(19) United States
(12) Patent Application Publication
(10) Pub. No.: US 2018/0301679 A1
(43) Pub. Date: Oct. 18, 2018

(54) COATING MATERIAL FOR NONAQUEOUS ELECTROLYTE SECONDARY BATTERY

(71) Applicant: Sumitomo Chemical Company, Limited, Tokyo (JP)

(72) Inventors: Junji SUZUKI, Niihama-shi (JP); Hiroki HASHIWAKI, Niihama-shi (JP)

(21) Appl. No.: 15/592,314

(22) Filed: May 11, 2017

(30) Foreign Application Priority Data
Apr. 14, 2017 (JP) 2017-080833

(51) Int. Cl. H01M 2/16; H01M 10/0525

(52) U.S. Cl. CPC H01M 2/1686; H01M 10/0525; H01M 2/166

(57) ABSTRACT

Realized is a nonaqueous electrolyte secondary battery coating material which is excellent in storage property, solution sending property, and coating property. The nonaqueous electrolyte secondary battery coating material has a first value and a second value which fall within respective given ranges, the first value being obtained by dividing a viscosity of the nonaqueous electrolyte secondary battery coating material at a shear rate of 0.1 sec⁻¹ by a viscosity of the nonaqueous electrolyte secondary battery coating material at a shear rate of 100 sec⁻¹, the second value being obtained by dividing the viscosity of the nonaqueous electrolyte secondary battery coating material at the shear rate of 0.1 sec⁻¹ by a viscosity of the nonaqueous electrolyte secondary battery coating material at a shear rate of 10,000 sec⁻¹.

This Nonprovisional application claims priority under 35 U.S.C. § 119 on Patent Application No. 2017-080833 filed in Japan on Apr. 14, 2017, the entire contents of which are hereby incorporated by reference.

### TECHNICAL FIELD

The present invention relates to a coating material for a nonaqueous electrolyte secondary battery (hereinafter, referred to as a nonaqueous electrolyte secondary battery coating material), a [symbol] :1 porous layer for a nonaqueous electrolyte secondary battery (hereinafter, referred to as a nonaqueous electrolyte secondary battery porous layer), a laminated separator for a nonaqueous electrolyte secondary battery (hereinafter, referred to as a nonaqueous electrolyte secondary battery laminated separator), a member for a nonaqueous electrolyte secondary battery (hereinafter, referred to as a nonaqueous electrolyte secondary battery member), and a nonaqueous electrolyte secondary battery.

### BACKGROUND ART

Nonaqueous electrolyte secondary batteries, particularly lithium ion secondary batteries, have a high energy density and are thus in wide use as batteries for personal computers, mobile telephones, portable information terminals, and the like. Such nonaqueous electrolyte secondary batteries have recently been developed as batteries for vehicles.

By the way, in accordance with an increase in energy density or capacity of lithium ion secondary batteries, safer mechanisms have been demanded. As such mechanisms, for example, the following mechanisms have been suggested: a multilayer porous film which is obtained by applying, to a separator that separates electrodes, a porous layer containing a metal oxide and a binder resin (Patent Literature 1); and an electrode to which a porous layer containing a metal oxide and a binder resin is applied (Patent Literature 2).

### CITATION LIST

### Patent Literature

### [Patent Literature 1]

Japanese Patent Application Publication Tokukai No. 2014-208780 (published on Nov. 6, 2014)

### [Patent Literature 2]

Japanese Patent Application Publication Tokukai No. 2010-244818 (published on Oct. 28, 2010)

### SUMMARY OF INVENTION

### Technical Problem

In those prior arts, a coating material is prepared by dispersing a filler, such as a metal oxide, and a binder resin in a solvent, and the coating material thus prepared is applied to a separator or an electrode. Such a coating material prepared by a conventional method unfortunately has a problem as below with its storage property. For example, in a case where the coating material is stored for a long time period, sedimentation of a filler occurs. In a case where the coating material is stored in a storage tank during a production process, it is possible to prevent the sedimentation of the filler by stirring the coating material. However, in particular, in a case where the coating material remains in a pipe for a long time, the sedimentation of the filler occurs. This sedimentation has been a serious problem.

As disclosed in the prior arts, it is possible to improve the storage property of the coating material to some extent by adding a thickener to the coating material. However, in a case where a large amount of thickener is added to the coating material so that a viscosity of the coating material is increased, problems arise such as a deterioration in handling easiness of the coating material in a step of sending the coating material and in a step of coating a separator or an electrode with the coating material.

An aspect of the present invention has been made in view of the above problems, and an object of the present invention is to realize a nonaqueous electrolyte secondary battery coating material which is excellent in storage property, solution sending property, and coating property.

### Solution to Problem

Under the circumstances, the inventors of the present invention carried out diligent research. As a result, the inventors found that, in a case where a coating material has (i) a high viscosity at a low shear rate which assumes a storing step and (ii) a low viscosity at a high shear rate which assumes a solution sending step and a coating step, it is possible to solve the above-mentioned problems and thus possible to attain the object. Specifically, the present invention has the following features:

[1] A nonaqueous electrolyte secondary battery coating material for forming a porous layer by applying the nonaqueous electrolyte secondary battery coating material to an electrode or a porous base material of a nonaqueous electrolyte secondary battery, the nonaqueous electrolyte secondary battery coating material including: a binder resin; a filler; and a solvent, the nonaqueous electrolyte secondary battery coating material having (i) a first thixotropic index of not less than 4 and not more than 400, the first thixotropic index being obtained by dividing a viscosity of the nonaqueous electrolyte secondary battery coating material at a shear rate of 0.1 sec⁻¹ by a viscosity of the nonaqueous electrolyte secondary battery coating material at a shear rate of 100 sec⁻¹ and (ii) a second thixotropic index of not less than 5 and not more than 40,000, the second thixotropic index being obtained by dividing the viscosity of the nonaqueous electrolyte secondary battery coating material at the shear rate of 0.1 sec⁻¹ by a viscosity of the nonaqueous electrolyte secondary battery coating material at a shear rate of 10,000 sec⁻¹.

[2] The nonaqueous electrolyte secondary battery coating material as set forth in [1], wherein the filler has a terminal velocity Vs of not more than 13 mm/sec, the terminal velocity Vs being obtained from the following Equation (1):

$$[ Math . 1 ]$$

$${V}_{S} = \frac{{D}_{90} \times ( {ρ}_{filler} - {ρ}_{solvent} ) \times ℊ}{18 \times {η}_{( 0.1 sec - 1 )}} \qquad ( 1 )$$

where: D₉₀ represents a particle diameter at which, in a case where volumes of particles constituting the filler are summed up in ascending order of particle diameters, a sum of the volumes reaches 90% of a total volume of the particles; ρ_{filler} represents a density of the filler; ρₛₒₗᵥₑₙₜ represents a density of the solvent; g represents gravitational acceleration; and η_{(0.1 sec-1)} represents the viscosity of the nonaqueous electrolyte secondary battery coating material at the shear rate of 0.1 sec⁻¹ which viscosity is measured with use of a rheometer.

[3] A nonaqueous electrolyte secondary battery porous layer obtained from a nonaqueous electrolyte secondary battery coating material recited in [1] or [2].

[4] A nonaqueous electrolyte secondary battery laminated separator including:

a polyolefin porous film; and

a nonaqueous electrolyte secondary battery porous layer recited in claim [3].

[5] A nonaqueous electrolyte secondary battery member including: a cathode; a nonaqueous electrolyte secondary battery porous layer recited in [3] or a nonaqueous electrolyte secondary battery laminated separator recited in [4]; and an anode, the cathode, the nonaqueous electrolyte secondary battery porous layer or the nonaqueous electrolyte secondary battery laminated separator, and the anode being disposed in this order.

[6] A nonaqueous electrolyte secondary battery including a nonaqueous electrolyte secondary battery porous layer recited in [3] or a nonaqueous electrolyte secondary battery laminated separator recited in [4].

### Advantageous Effects of Invention

According to an aspect of the present invention, it is possible to realize a nonaqueous electrolyte secondary battery coating material which is excellent in storage property, solution sending property, and coating property.

### DESCRIPTION OF EMBODIMENTS

The following description will discuss an embodiment of the present invention. Note, however, that the present invention is not limited to the embodiment. The present invention is not limited to the description of the arrangements below, but may be altered by a skilled person in the art within the scope of the claims. An embodiment derived from a proper combination of technical means disclosed in different embodiments is also encompassed in the technical scope of the present invention. Note that, in the present specification, any numerical range expressed as “A to B” means “not less than A and not more than B” unless otherwise stated.

[1. Nonaqueous Electrolyte Secondary Battery Coating Material]

A nonaqueous electrolyte secondary battery coating material (hereinafter, also simply referred to as a coating material) in accordance with an embodiment of the present invention is a nonaqueous electrolyte secondary battery coating material for forming a porous layer by applying the nonaqueous electrolyte secondary battery coating material to an electrode or a porous base material of a nonaqueous electrolyte secondary battery, the nonaqueous electrolyte secondary battery coating material including: a binder resin; a filler; and a solvent, the nonaqueous electrolyte secondary battery coating material having (i) a first thixotropic index of not less than 4 and not more than 400, the first thixotropic index being obtained by dividing a viscosity of the nonaqueous electrolyte secondary battery coating material at a shear rate of 0.1 sec⁻¹ by a viscosity of the nonaqueous electrolyte secondary battery coating material at a shear rate of 100 sec⁻¹ and (ii) a second thixotropic index of not less than 5 and not more than 40,000, the second thixotropic index being obtained by dividing the viscosity of the nonaqueous electrolyte secondary battery coating material at the shear rate of 0.1 sec⁻¹ by a viscosity of the nonaqueous electrolyte secondary battery coating material at a shear rate of 10,000 sec⁻¹.

<1-1. Thixotropic Index>

The inventors of the present invention found that it is possible to realize a coating material which is excellent in storage property, solution sending property, and coating property, by controlling thixotropy of the coating material. As a result, the inventors completed the present invention. Thixotropy indicates a phenomenon in which a viscosity becomes lower as a shear rate becomes higher. In the present specification, a storage property indicates stability of a coating material in a state where the coating material is stored. A solution sending property indicates ease of sending the coating material through a pipe and the like. A coating property indicates ease of handling the coating material in a case where the coating material is applied to an electrode or a porous base material (handling easiness).

Thixotropy is exhibited by a system having a structure in which the system breaks down depending on a shear rate in a case where the system is deformed by being sheared. It is generally known that such a structure is seen in a case where media moderately interact with each other in a certain kind of polymer solution or in a system in which a certain kind of filler is dispersed. Thixotropy is also a phenomenon in which shear stress is reduced depending on time. Therefore, it is known that a system having thixotropy generally exhibits hysteresis behavior, that is, varies in viscosity between (i) a case where a shear rate is increased from a state where the system is allowed to stand still for a long time and (ii) a case where the shear rate is reduced from a state where the system is sheared. A viscosity attained in a case where a shear rate is increased is higher than that attained in a case where the shear rate is reduced.

As an index indicative of thixotropy, a thixotropic index (TI value) is generally used. A TI value is a value obtained by dividing a viscosity at a low shear rate by a viscosity at a high shear rate. In a case where a system has a TI value of more than 1 (one), it can be said that such a system has thixotropy.

A coating material which has high thixotropy has a high viscosity at a low shear rate (that is, a viscosity of the coating material, which viscosity assumes a storing step, is high). This causes sedimentation of a filler to be suppressed, and ultimately causes an improvement in storage property. On the other hand, the coating material has a low viscosity at a high shear rate (that is, a viscosity of the coating material, which viscosity assumes a solution sending step and a coating step, is low). This causes the coating material to be easily sent. Furthermore, this causes the coating material to have a good leveling property in the coating step, and ultimately causes the coating material to have such good handling easiness that, for example, an electrode or a porous base material can be coated with the coating material having a uniform thickness. Accordingly, a coating material which has moderately high thixotropy can have a good storage property, a good solution sending property, and a good coating property.

In order for a coating material to have both a good storage property and a good solution sending property, a thixotropic index of the coating material which thixotropic index is obtained by dividing a viscosity of the coating material at a shear rate of 0.1 sec⁻¹ by a viscosity of the coating material at a shear rate of 100 sec⁻¹ is preferably not less than 4 and not more than 400, more preferably not less than 5 and not more than 300. The coating material which has a thixotropic index falling within the above range has a sufficient viscosity in the storing step, and has such a low viscosity in the solution sending step that the coating material can be easily sent. Note that, in the following description, the thixotropic index obtained by dividing the viscosity of the coating material at the shear rate of 0.1 sec⁻¹ by the viscosity of the coating material at the shear rate of 100 sec⁻¹ is also referred to as a “0.1/100 thixotropic index.”

Furthermore, in order for the coating material to have both the good storage property and a good coating property, a thixotropic index of the coating material which thixotropic index is obtained by dividing the viscosity of the coating material at the shear rate of 0.1 sec⁻¹ by a viscosity of the coating material at a shear rate of 10,000 sec⁻¹ is preferably not less than 5 and not more than 40,000, more preferably not less than 10 and not more than 30,000. The coating material which has a thixotropic index falling within the above range has a sufficient viscosity in the storing step, and has such a low viscosity in the coating step that the coating material is good in handling easiness. Note that, in the following description, the thixotropic index obtained by dividing the viscosity of the coating material at the shear rate of 0.1 sec⁻¹ by the viscosity of the coating material at the shear rate of 10,000 sec⁻¹ is also referred to as a “0.1/10,000 thixotropic index.”

In view of the storage property, the viscosity at the shear rate of 0.1 sec⁻¹ is preferably not less than 0.5 Pa·sec, more preferably not less than 5 Pa·sec, still more preferably not less than 10 Pa·sec.

Note, however, that, in a case where the viscosity at such a low shear rate is excessively high, the following problem can be, for example, caused. That is, in a case where operation and non-operation are repeated during a production process, it is not possible to send the coating material. Therefore, there is a limitation on the viscosity at the low shear rate in terms of a process. In view of this, the viscosity at the shear rate of 0.1 sec⁻¹ is preferably not more than 1,000 Pa·sec, more preferably not more than 100 Pa·sec.

Furthermore, in view of ease of sending the coating material, the viscosity at the shear rate of 100 sec⁻¹ is preferably not more than 2 Pa·sec, more preferably not more than 1.5 Pa·sec. Note that, in view of difficulty of causing sedimentation of a filler, the viscosity at the shear rate of 100 sec⁻¹ is preferably not less than 0.05 Pa·sec, more preferably not less than 0.1 Pa·sec.

In view of handling easiness of the coating material in the coating step, the viscosity at the shear rate of 10,000 sec⁻¹ is preferably not more than 0.15 Pa·sec, more preferably not more than 0.1 Pa·sec. Note that a lower limit of the viscosity at the shear rate of 10,000 sec⁻¹ is not limited in particular, but can be, for example, not less than 0.01 Pa·sec.

Examples of a method of imparting thixotropy to a coating material encompass a method in which a resin that causes thixotropy to be exhibited is used as a binder resin (later described) or added to the coating material in addition to the binder resin. Thixotropy is exhibited, as has been described, in a case where a network structure is formed in a solution. Therefore, it is possible to increase the resin's ability to cause thixotropy to be exhibited, by designing a molecule such that the molecule has, in part of its molecular structure, a structure that forms a hydrogen bond, an ionic bond, a van der Waals bond, or the like. In a case where the binder resin's ability to cause thixotropy to be exhibited is insufficient, it is possible to increase thixotropy of the coating material by adding, to the coating material in addition to the binder resin, the resin which causes thixotropy to be exhibited. In a case where two or more kinds of resins are used in combination as described above, it is possible to easily control (i) thixotropic indices of the coating material so that the thixotropic indices fall within the respective above-described ranges and (ii) viscosities of the coating material so that the viscosities fall within the respective above-described ranges, while maintaining a characteristic of the binder resin.

Note that the prior arts (for example, Patent Literature 2) disclose a method of imparting thixotropy to a coating material by use of fumed alumina. It is considered that, since bonding between particles of fumed alumina is relatively strong, the coating material exhibits thixotropy. However, the thixotropy which can be imparted to the coating material by this method is lower than that imparted to the coating material by addition of the above-described resin.

Examples of the resin which causes thixotropy to be exhibited encompass: synthetic polymers such as para-aramid, modified polyvinylidene fluoride (modified PVdF), modified acrylic resin, and modified polyvinyl alcohol; cellulose derivatives; and natural polysaccharides such as carrageenan.

<1-2. Binder Resin>

The coating material in accordance with an embodiment of the present invention contains a binder resin. The binder resin is used for binding of a filler. The binder resin can be constituted by one kind of polymer or can be alternatively constituted by a mixture of two or more kinds of polymers. In the present specification, a generic name for a polymer represents a type of a bond which the polymer mainly has. For example, in a case where a polymer is an aromatic polymer which is referred to as “aromatic polyester”, such a generic name “aromatic polyester” indicates that not less than 50% of bonds, constituting a main chain, in molecules of the aromatic polymer are ester bonds. Note, however, that the aromatic polymer referred to as “aromatic polyester” can contain, in the bonds constituting the main chain, bonds other than the ester bonds (such as an amide bond and an imide bond).

The binder resin preferably has heat resistance so that a porous layer obtained from the coating material can maintain heat resistance even in a case where the porous layer is exposed to a high temperature in a battery. The term “heat resistance” used here for the binder resin means that the binder resin does not undergo a chemical reaction or does not flow at least at a temperature of 150° C. Furthermore, in a case where a pyrolysis temperature of the binder resin is not less than 300° C., it is possible to increase stability of the porous layer. This ultimately allows a safer battery to be provided.

The binder resin is preferably insoluble in an electrolyte of a battery and is preferably electrochemically stable when the battery is in normal use. Specific examples of the binder resin encompass thermoplastic resins. Examples of the thermoplastic resins encompass: polyolefins such as polyethylene, polypropylene, polybutene, and an ethylene-propylene copolymer; fluorine-containing resins such as polyvinylidene fluoride (PVDF), polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoro ethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer, and any of these fluorine-containing resins which is a fluorine-containing rubber having a glass transition temperature of not more than 23° C.; aromatic polymers; polycarbonate; polyacetal; rubbers such as a styrene-butadiene copolymer and a hydride thereof, a methacrylic acid ester copolymer, an acrylonitrile-acrylic acid ester copolymer, a styrene-acrylic acid ester copolymer, ethylene propylene rubber, and polyvinyl acetate; resins having a melting point or a glass transition temperature of not less than 180° C. such as polysulfone and polyester; water-soluble polymers such as polyvinyl alcohol, polyethylene glycol, cellulose ether, sodium alginate, polyacrylic acid, polyacrylamide, and polymethacrylic acid.

The binder resin contained in the porous layer in accordance with an embodiment of the present invention is preferably an aromatic polymer. The aromatic polymer is preferably a wholly aromatic polymer which does not have an aliphatic carbon in a main chain. Note, here, that the “aromatic polymer” indicates a polymer in which a structural unit constituting a main chain contains an aromatic ring. That is, this means that monomers serving as raw materials of a thermoplastic resin include an aromatic compound.

Specific examples of the aromatic polymer encompass aromatic polyamide, aromatic polyimide, aromatic polyester, aromatic polycarbonate, aromatic polysulfone, and aromatic polyether. Preferable examples of the aromatic polymer encompass aromatic polyamide, aromatic polyimide, and aromatic polyester.

Examples of the aromatic polyamide encompass: wholly aromatic polyamides such as para-aramid and meta-aramid; semi-aromatic polyamide; 6T nylon; 61 nylon; 8T nylon; 10T nylon; modified 6T nylon; modified 61 nylon; modified 8T nylon; modified 10T nylon; and copolymers of these.

Examples of the aromatic polyester encompass the following polyesters. These aromatic polyesters are preferably wholly aromatic polyesters.
(1) A polymer obtained by polymerizing an aromatic hydroxycarboxylic acid, an aromatic dicarboxylic acid, and an aromatic diol,
(2) A polymer obtained by polymerizing aromatic hydroxycarboxylic acids of identical type or differing types,
(3) A polymer obtained by polymerizing an aromatic dicarboxylic acid and an aromatic diol,
(4) A polymer obtained by polymerizing (i) an aromatic hydroxycarboxylic acid, (ii) an aromatic dicarboxylic acid, and (iii) an aromatic amine having a phenolic hydroxide group,
(5) A polymer obtained by polymerizing (i) an aromatic dicarboxylic acid and (ii) an aromatic amine having a phenolic hydroxide group,
(6) A polymer obtained by polymerizing an aromatic hydroxycarboxylic acid, an aromatic dicarboxylic acid, and an aromatic diamine,
(7) A polymer obtained by polymerizing an aromatic hydroxycarboxylic acid, an aromatic dicarboxylic acid, an aromatic diamine, and an aromatic diol, and
(8) A polymer obtained by polymerizing (i) an aromatic hydroxycarboxylic acid, (ii) an aromatic dicarboxylic acid, (iii) an aromatic amine having a phenolic hydroxide group, and (iv) an aromatic diol.

Out of the aromatic polyesters above, the aromatic polyesters of (4) through (7) or (8) are preferable in view of solubility in a solvent. Excellent solubility in a solvent allows an increase in productivity of the porous layer.

Note that instead of using an aromatic hydroxycarboxylic acid, aromatic dicarboxylic acid, an aromatic diol, an aromatic diamine, or an aromatic amine having a phenolic hydroxide group, it is possible to use (i) an ester-forming derivative of any of these or (ii) an amide-forming derivative of any of these.

The wholly aromatic polyesters each preferably contain (i) a repeating structural unit, in an amount of 10 mol % to 50 mol %, derived from at least one compound selected from the group consisting of p-hydroxybenzoic acid and 2-hydroxy-6-naphthoic acid, (ii) a repeating structural unit, in an amount of 10 mol % to 50 mol %, derived from at least one compound selected from the group consisting of 4-hydroxyaniline and 4,4′-diaminodiphenyl ether, (iii) a repeating structural unit, in an amount of 10 mol % to 50 mol %, derived from at least one compound selected from the group consisting of a terephthalic acid and an isophthalic acid, and (iv) a repeating structural unit, in an amount of 10 mol % to 19 mol %, derived from hydrochinone. The wholly aromatic polyesters each particularly preferably contain (i) a repeating structural unit, in an amount of 10 mol % to 35 mol %, derived from 4-hydroxyaniline and (ii) a repeating structural unit, in an amount of 20 mol % to 45 mol %, derived from an isophthalic acid.

A method of preparing the binder resin is not limited to any particular one, and a method known to a person skilled in the art can be employed.

Each of the coating material in accordance with an embodiment of the present invention and the porous layer, which is obtained from the coating material, in accordance with an embodiment of the present invention preferably contains (i) a resin which causes thixotropy to be exhibited and (ii) a resin which causes thixotropy to be hardly exhibited or a resin which causes, by itself, thixotropy not to be exhibited. This causes the coating material to be excellent in storage property, solution sending property, and coating property, and further causes the porous layer to be excellent in ion permeability. Examples of the resin which causes thixotropy to be hardly exhibited encompass polyester resins. The resin which causes thixotropy to be hardly exhibited or the resin which causes thixotropy not to be exhibited is a resin which causes a mixture containing the resin and a solvent to have (i) a 0.1/100 thixotropic index of less than 4 and (ii) a 0.1/10,000 thixotropic index of less than 5.

The resin which causes thixotropy to be exhibited is contained, in the coating material, in an amount of preferably not less than 5 parts by weight and not more than 95 parts by weight, more preferably not less than 9 parts by weight and not more than 90 parts by weight, relative to 100 parts by weight of the binder resin.

Note that another additive can be added to the coating material, provided that the effects of the present invention are brought about.

<1-3. Filler>

The coating material in accordance with an embodiment of the present invention contains a filler. Examples of the filler encompass: inorganic oxides such as alumina, silica, titania, zirconia, magnesia, aluminum hydroxide, barium titanate, and calcium carbonate; and minerals such as mica, zeolite, kaolin, and talc. Each of those fillers can be used solely. Alternatively, two or more of those fillers can be used in combination. Out of those fillers, alumina is preferable in view of chemical stability. Furthermore, fumed alumina is more preferable because it is possible to cause thixotropy to be exhibited.

An amount of the filler contained in the coating material can be set as appropriate depending on a specific gravity of a material of the filler. For example, in a case where all of particles constituting the filler are alumina particles, a weight of the filler is normally not less than 20% by weight and not more than 95% by weight, preferably not less than 30% by weight and not more than 90% by weight, relative to a total weight of the coating material.

The filler is constituted by particles each having a substantially spherical shape, a plate-like shape, a pillar shape, a needle shape, a whisker-like shape, a fibrous shape, or the like. In particular, the filler is preferably constituted by substantially spherical particles because the substantially spherical particles allow uniform pores to be easily made. In view of strength and smoothness of the porous layer, an average particle diameter of the particles by which the filler is constituted is preferably not less than 0.01 μm and not more than 1 μm. Note that, as the average particle diameter, a value measured with use of a photograph taken by a scanning electron microscope is used. Specifically, any 50 particles of particles captured in the photograph are selected, respective particle diameters of the 50 particles are measured, and then an average value of the particle diameters thus measured is used as the average particle diameter.

According to the Stokes' equation, it is considered that a sedimentation rate of particles dispersed in a liquid converges to a terminal velocity Vs. A terminal velocity Vs is obtained by the following equation (1) where: D represents a particle diameter; ρ_{filler} represents a density of particles (filler); ρₛₒₗᵥₑₙₜ represents a density of a solvent; g represents a gravitational constant (gravitational acceleration [9.8 m/sec²]); and η represents a viscosity of a dispersion liquid. Note that, since sedimentation of the filler is taken into consideration, D₉₀ is employed as the particle diameter D, and a viscosity (η_{(0.1 sec-}1) ) at a shear rate of 0.1 sec⁻¹, which viscosity is measured with use of a rheometer, is employed as the viscosity η. D₉₀ is a particle diameter at which, in a case where volumes of the particles constituting the filler are summed up in ascending order of particle diameters, a sum of the volumes thus summed up reaches 90% of a total volume of the particles.

$$[ Math . 2 ]$$

$${V}_{S} = \frac{{D}_{90} \times ( {ρ}_{filler} - {ρ}_{solvent} ) \times ℊ}{18 \times {η}_{( 0.1 sec - 1 )}} \qquad ( 1 )$$

Note that, in a case where two or more kinds of fillers are used in combination, a density of one of the fillers which one is larger in particle diameter is employed as ρ_{filler}. Note also that, in a case where two or more kinds of solvents are used in combination, an actually measured density is employed as ρₛₒₗᵥₑₙₜ.

According to the coating material in accordance with an embodiment of the present invention, the filler has a terminal velocity Vs, which is obtained from the equation (1), of preferably not more than 13 mm/sec, more preferably not more than 10 mm/sec. The filler which has a terminal velocity Vs of not more than 13 mm/sec is less likely to sediment. Therefore, in view of the storage property of the coating material, it is preferable that the filler have a terminal velocity Vs of not more than 13 mm/sec.

<1-4. Solvent>

The coating material in accordance with an embodiment of the present invention contains a solvent. The solvent serves as a dispersion medium because the solvent dissolves a resin and causes a filler to be dispersed in the solvent. The solvent is not limited to any particular one, provided that the solvent (i) does not have an adverse effect on an object to which the coating material is applied, (ii) uniformly and stably dissolves the resin, (iii) causes the filler to be uniformly and stably dispersed in the solvent. Specific examples of the solvent encompass aprotic solvents such as N-methyl-2-pyrrolidone, N,N-dimethylacetamide, and N,N-dimethylformamide. The aprotic solvents can be aprotic polar solvents. Each of those solvents can be used solely. Alternatively, two or more of those solvents can be used in combination.

<1-5. Method of Producing Coating Material>

Examples of a method of producing the coating material encompass a method in which (i) the resin is dissolved in the solvent and (ii) the filler is dispersed in the solvent.

The filler and the resin which causes thixotropy to be exhibited may partially aggregate due to intermolecular interaction. Partial aggregation of the filler and the resin causes an increase in sedimentation rate, and ultimately causes a deterioration in storage property. In order for the coating material not to have such an aggregate, it is preferable to add sufficient energy to the aggregate with use of a dispersing device so that the aggregate is crushed. The aggregate can be crushed by, for example, a mechanical stirring method in which a high-pressure dispersing device, a counter collision type dispersing device, a ball mill, a bead mill, a paint shaker, a high-speed impeller dispersing device, an ultrasonic dispersing device, a homogenizer, or a stirring blade is used. Since the high-pressure dispersing device has a great ability to crush the aggregate, it is particularly preferable to employ the high-pressure dispersing device.

It is preferable that the coating material have a higher solid content concentration because such a coating material contains the solvent in a smaller amount and, accordingly, less time and effort are taken to volatilize the solvent during production of the porous layer. For example, the coating material has a solid content concentration of preferably not less than 5% by weight, more preferably not less than 8% by weight. In view of fluidity of the coating material, the coating material has a solid content concentration of preferably not more than 50% by weight, more preferably not more than 20% by weight.

[2. Porous Layer]

The porous layer for a nonaqueous electrolyte secondary battery in accordance with an embodiment of the present invention (hereinafter, also simply referred to as a porous layer) is obtained from the nonaqueous electrolyte secondary battery coating material. Note that, in a case where the coating material is used, the filler is dispersed, so that the porous layer which hardly has unevenness is obtained. However, it is difficult to define a degree of dispersion of the filler or a degree of unevenness of the porous layer as a parameter indicative of a physical property of the porous layer.

A thickness of the porous layer can be decided as appropriate in view of a thickness of a separator for a nonaqueous electrolyte secondary battery (hereinafter, referred to as a nonaqueous electrolyte secondary battery separator) to be produced. In a case where (i) a porous film is used as a porous base material and (ii) the porous layer is disposed on one surface or both surfaces of the porous film, the thickness of the porous layer is preferably 0.5 μm to 15 μm (per surface of the porous film), more preferably 2 μm to 10 μm (per surface of the porous film).

In a case where the thickness of the porous layer is not less than 1 μm (not less than 0.5 μm per surface of the porous film), it is possible to sufficiently prevent an internal short circuit of a battery which internal short circuit is caused by breakage or the like of the battery, and furthermore possible to sufficiently maintain an amount of an electrolyte retained in the porous layer. In a case where a total thickness of the porous layer disposed on the both surfaces of the porous film is not more than 30 μm (not more than 15 μm per surface of the porous film), it is possible to prevent a deterioration in rate characteristic and cycle characteristic.

Examples of a method of producing the porous layer encompass a method in which the foregoing coating material is prepared, applied to a base material, and then dried so that a solid content of the coating material is deposited as the porous layer. Note that examples of the base material encompass a porous base material (for example, polyolefin porous film (later described)) and an electrode.

As a method of coating the base material with the coating material, a publicly known coating method, such as a knife coater method, a blade coater method, a bar coater method, a gravure coater method, or a die coater method, can be employed.

In general, by drying the coating material, the solvent (dispersion medium) is removed. Examples of a method of drying the coating material encompass natural drying, air-blowing drying, heat drying, and drying under reduced pressure. Note, however, that any method can be employed, provided that the solvent (dispersion medium) can be sufficiently removed. Note also that the coating material can be dried after the solvent (dispersion medium) contained in the coating material is replaced with another solvent. Specific examples of a method of replacing the solvent (dispersion medium) with another solvent and then drying the coating material encompass a method in which (i) the solvent (dispersion medium) is replaced with a poor solvent having a low boiling point, such as water, alcohol, or acetone, and (ii) the coating material is dried so that the poor solvent is removed and the solid content of the coating material is deposited as the porous layer.

[3. Nonaqueous Electrolyte Secondary Battery Laminated Separator]

A nonaqueous electrolyte secondary battery laminated separator in accordance with an embodiment of the present invention includes a polyolefin porous film and the foregoing nonaqueous electrolyte secondary battery porous layer.

As a thickness of the nonaqueous electrolyte secondary battery laminated separator is reduced, energy density of a battery is increased. Therefore, the nonaqueous electrolyte secondary battery laminated separator preferably has a less thickness. However, a less thickness also leads to less strength, and there is therefore a limitation on a reduction in thickness during production of the nonaqueous electrolyte secondary battery laminated separator. In view of these factors, the nonaqueous electrolyte secondary battery laminated separator in accordance with an embodiment of the present invention has a thickness of preferably not more than 50 μm, more preferably not more than 25 μm, and still more preferably not more than 20 μm. In addition, the nonaqueous electrolyte secondary battery laminated separator preferably has a thickness of not less than 5 μm.

Note that the nonaqueous electrolyte secondary battery laminated separator in accordance with an embodiment of the present invention can include, as needed, a publicly known porous film such as an adhesive layer or a protection layer in addition to the polyolefin porous film and the porous layer, provided that the object of the present invention is not impaired.

<3-1. Polyolefin Porous Film>

The nonaqueous electrolyte secondary battery separator in accordance with an embodiment of the present invention includes a polyolefin porous film, and is preferably constituted by a polyolefin porous film. The polyolefin porous film has therein many pores, connected to one another, so that a gas and a liquid can pass through the polyolefin porous film from one side to the other side. The polyolefin porous film can be a base material of the nonaqueous electrolyte secondary battery laminated separator. In a case where a battery generates heat, the polyolefin porous film melts so as to make the nonaqueous electrolyte secondary battery separator non-porous. Thus, the polyolefin porous film can impart a shutdown function to the nonaqueous electrolyte secondary battery separator.

Note, here, that the “polyolefin porous film” is a porous film which contains a polyolefin-based resin as a main component. Note that the phrase “contains a polyolefin-based resin as a main component” means that a porous film contains a polyolefin-based resin at a proportion of not less than 50% by volume, preferably not less than 90% by volume, more preferably not less than 95% by volume, relative to the whole of materials of which the porous film is made. Note also that, hereinafter, the polyolefin porous film is also simply referred to as a “porous film.”

The polyolefin-based resin which the porous film contains as a main component is not limited to any particular one. Examples of the polyolefin-based resin encompass homopolymers and copolymers each of which homopolymers and copolymers is a thermoplastic resin and is produced through polymerization of a monomer(s) such as ethylene, propylene, 1-butene, 4-methyl-1-pentene, and/or 1-hexene. Specifically, examples of such homopolymers encompass polyethylene, polypropylene, and polybutene, and examples of such copolymers encompass an ethylene-propylene copolymer. The porous film can be a layer containing any one of those polyolefin-based resins or can be alternatively a layer containing two or more of those polyolefin-based resins. Out of those polyolefin-based resins, polyethylene is more preferable because it is possible to prevent (shutdown), at a lower temperature, a flow of an excessively large current. In particular, high molecular weight polyethylene which contains ethylene as a main component is preferable. Note that the porous film can contain a component other than polyolefin, provided that the component does not impair a function of the layer.

Examples of the polyethylene encompass low-density polyethylene, high-density polyethylene, linear polyethylene (ethylene-a-olefin copolymer), and ultra-high molecular weight polyethylene. Out of those polyethylenes, ultra-high molecular weight polyethylene is more preferable, and ultra-high molecular weight polyethylene which contains a high molecular weight component having a weight-average molecular weight of 5×10⁵ to 15×10⁶ is still more preferable. In particular, the polyolefin-based resin which contains a high molecular weight component having a weight-average molecular weight of not less than 1,000,000 is more preferable because the porous film and the nonaqueous electrolyte secondary battery laminated separator are increased in strength.

The porous film has a thickness of preferably 4 μm to 40 μm, more preferably 5 μm to 20 μm. It is preferable that the porous film have a thickness of not less than 4 μm, because it is possible to sufficiently prevent an internal short circuit of a battery. Meanwhile, it is preferable that the porous film has a thickness of not more than 40 μm, because it is possible to prevent a nonaqueous electrolyte secondary battery from being large in size.

The porous film has [symbol] :35 a weight per unit area of normally 4 g/m² to 20 g/m², preferably 5 g/m² to 12 g/m² so that a battery has a high weight energy density and a high volume energy density.

The porous film has Gurley air permeability of preferably 30 sec/100 mL to 500 sec/100 mL, more preferably 50 sec/100 mL to 300 sec/100 mL. This makes it possible for the nonaqueous electrolyte secondary battery laminated separator to achieve sufficient ion permeability.

The porous film has a porosity of preferably 20% by volume to 80% by volume, more preferably 30% by volume to 75% by volume. This makes it possible to (i) increase an amount of an electrolyte retained in the porous film and (ii) absolutely prevent (shutdown), at a lower temperature, a flow of an excessively large current.

A pore diameter of the pores which the porous film has is preferably not more than 0.3 μm, more preferably not more than 0.14 μm. This makes it possible for the nonaqueous electrolyte secondary battery laminated separator to achieve sufficient ion permeability. Furthermore, this makes it possible to prevent particles, constituting an electrode, from entering the nonaqueous electrolyte secondary battery laminated separator.

A method of producing the porous film can be any publicly known method, and is not limited to any particular one. For example, as disclosed in Japanese Patent No. 5476844, the porous film can be produced by (i) adding a filler to a thermoplastic resin, (ii) forming, into a film, the thermoplastic resin containing the filler, and then (iii) removing the filler.

Specifically, in a case where, for example, the porous film is made of a polyolefin resin containing ultra-high molecular weight polyethylene and low molecular weight polyolefin which has a weight-average molecular weight of not more than 10,000, the porous film is preferably produced by, in view of production costs, a method including the following steps (1) through (4):
(1) kneading 100 parts by weight of ultra-high molecular weight polyethylene, 5 parts by weight to 200 parts by weight of low molecular weight polyolefin having a weight-average molecular weight of not more than 10,000, and 100 parts by weight to 400 parts by weight of an inorganic filler such as calcium carbonate, so that a polyolefin resin composition is obtained;
(2) forming the polyolefin resin composition into a sheet;
(3) removing the inorganic filler from the sheet obtained in the step (2); and
(4) stretching the sheet obtained in the step (3).

Alternatively, the porous film can be produced through a method disclosed in any of the foregoing Patent Literatures.

Alternatively, the porous film can be a commercially available product having the above-described characteristics.

<3-2. Method of Producing Nonaqueous Electrolyte Secondary Battery Laminated Separator>

The nonaqueous electrolyte secondary battery laminated separator in accordance with an embodiment of the present invention can be produced by, for example, a method in which the polyolefin porous film is used as a base material in the above-described method of producing the porous layer in accordance with an embodiment of the present invention.

[4. Nonaqueous Electrolyte Secondary Battery Member]

A nonaqueous electrolyte secondary battery member in accordance with an embodiment of the present invention is a nonaqueous electrolyte secondary battery member including: a cathode; the foregoing nonaqueous electrolyte secondary battery porous layer or the foregoing nonaqueous electrolyte secondary battery laminated separator; and an anode, the cathode, the nonaqueous electrolyte secondary battery porous layer or the nonaqueous electrolyte secondary battery laminated separator, and the anode being disposed in this order.

<4-1. Cathode>

A cathode is not limited to any particular one, provided that the cathode is one that is typically used as a cathode of a nonaqueous electrolyte secondary battery. Examples of the cathode encompass a cathode sheet having a structure in which an active material layer containing a cathode active material and a binder resin is formed on a current collector. The active material layer can further contain an electrically conductive agent and/or a binding agent.

The cathode active material is, for example, a material capable of being doped with and dedoped of lithium ions. Specific examples of such a material encompass a lithium complex oxide containing at least one transition metal such as V, Mn, Fe, Co, or Ni.

Examples of the electrically conductive agent encompass carbonaceous materials such as natural graphite, artificial graphite, cokes, carbon black, pyrolytic carbons, carbon fiber, and a fired product of an organic polymer compound. It is possible to use (i) only one kind of the above electrically conductive agents or (ii) two or more kinds of the above electrically conductive agents in combination.

Examples of the binding agent encompass: fluorine-based resins such as polyvinylidene fluoride; acrylic resin; and styrene butadiene rubber. Note that the binding agent serves also as a thickener.

Examples of the cathode current collector encompass electric conductors such as Al, Ni, and stainless steel. Out of those electric conductors, Al is preferable because Al is easily processed into a thin film and is inexpensive.

Examples of a method of producing the cathode sheet encompass: a method in which the cathode active material, the electrically conductive agent, and the binding agent are pressure-molded on the cathode current collector; and a method in which (i) the cathode active material, the electrically conductive agent, and a binding agent are formed into a paste with use of a suitable organic solvent, (ii) the cathode current collector is coated with the paste, and then (iii) the paste is dried and then pressured so that the paste is firmly fixed to the cathode current collector.

<4-2. Anode>

An anode is not limited to any particular one, provided that the anode is a one that is typically used as an anode of a nonaqueous electrolyte secondary battery. Examples of the anode encompass an anode sheet having a structure in which an active material layer containing an anode active material and a binder resin is formed on a current collector. The active material layer can further contain an electrically conductive auxiliary agent.

The anode active material is, for example, a material capable of being doped with and dedoped of lithium ions, lithium metal, or lithium alloy. Examples of such a material encompass carbonaceous materials such as natural graphite, artificial graphite, cokes, carbon black, and pyrolytic carbons.

Examples of the anode current collector encompass Cu, Ni, and stainless steel. Out of those, Cu is more preferable because Cu is not easily alloyed with lithium particularly in a lithium ion secondary battery and is easily processed into a thin film.

Examples of a method of producing the anode sheet encompass: a method in which the anode active material is pressure-molded on the anode current collector; and a method in which (i) the anode active material is formed into a paste with use of a suitable organic solvent, (ii) the anode current collector is coated with the paste, and then (iii) the paste is dried and then pressured so that the paste is firmly fixed to the anode current collector.

The paste preferably contains the electrically conductive auxiliary agent. Furthermore, the paste preferably contains a binding agent which can be contained in the active material layer of the cathode.

<4-3. Method of Producing Nonaqueous Electrolyte Secondary Battery Member>

Examples of a method of producing the nonaqueous electrolyte secondary battery member in accordance with an embodiment of the present invention encompass a method in which the cathode, the nonaqueous electrolyte secondary battery separator or the nonaqueous electrolyte secondary battery laminated separator, and the anode are disposed in this order. Note that the method of producing the nonaqueous electrolyte secondary battery member is not limited to any particular one, and a conventionally publicly known producing method can be employed.

[5. Nonaqueous Electrolyte Secondary Battery]

A nonaqueous electrolyte secondary battery in accordance with an embodiment of the present invention includes the foregoing nonaqueous electrolyte secondary battery porous layer or the foregoing nonaqueous electrolyte secondary battery laminated separator.

<5-1. Method of Producing Nonaqueous Electrolyte Secondary Battery>

A method of producing the nonaqueous electrolyte secondary battery is not limited to any particular one, and a conventionally publicly known method can be employed. For example, it is possible to produce the nonaqueous electrolyte secondary battery in accordance with an embodiment of the present invention by (i) forming the nonaqueous electrolyte secondary battery member by the above-described method, (ii) inserting the nonaqueous electrolyte secondary battery member into a container for use as a housing of the nonaqueous electrolyte secondary battery, (iii) filling the container with a nonaqueous electrolyte, and then (iv) hermetically sealing the container under reduced pressure.

<5-2. Nonaqueous Electrolyte>

The nonaqueous electrolyte is not limited to any particular one, provided that the nonaqueous electrolyte is one that is typically used for a nonaqueous electrolyte secondary battery. The nonaqueous electrolyte can be one prepared by dissolving a lithium salt in an organic solvent. Examples of the lithium salt encompass LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCl₄. It is possible to use (i) only one kind of those lithium salts or (ii) two or more kinds of those lithium salts in combination.

Examples of the organic solvent to be contained in the nonaqueous electrolyte encompass carbonates, ethers, esters, nitriles, amides, carbamates, a sulfur-containing compound, and a fluorine-containing organic solvent obtained by introducing a fluorine group into any of these organic solvents. It is possible to use (i) only one kind of those organic solvents or (ii) two or more kinds of those organic solvents in combination.

### EXAMPLES

The following description will discuss an embodiment of the present invention in more detail by Examples and Comparative Examples. Note, however, that the present invention is not limited to these Examples and Comparative Examples.

[Measurement]

First, each of coating materials prepared in Examples and Comparative Examples was stirred for 3 minutes at 10,000 rpm with use of a homogenizer T18 digital ULTRA TURRAX (output: 300W) manufactured by IKA in combination with a shaft S18N-10G manufactured by IKA. The each of the coating materials was then dispersed twice at 50 MPa with use of a high-pressure dispersion homogenizer L01-YH1 (output: 750 W, processing capacity: 180 ml/min) manufactured by Sanwa Engineering Co. Ltd. Thereafter, the following physical properties of the each of the coating materials were measured.

<Particle Diameter>

Particle diameters were measured with use of a laser diffraction particle size analyzer SALD-2200 manufactured by Shimazu Corporation. Measurement was carried out in a state where each of the coating materials was diluted, as needed, with N-methyl-2-pyrrolidone (hereinafter, referred to as NMP) serving as a dispersion medium. As the particle diameters, D₅₀ and D₉₀ were measured. Note that D₅₀ is a particle diameter at which, in a case where volumes of particles constituting a filler are summed up in ascending order of particle diameters, a sum of the volumes thus summed up reaches 50% of a total volume of the particles. Note, also, that D₉₀ is a particle diameter at which, in a case where the volumes of the particles constituting the filler are summed up in ascending order of the particle diameters, the sum of the volumes thus summed up reaches 90% of the total volume of the particles.

<Rotational Viscometer Measurement>

Viscosities of each of the coating materials at given shear rates were measured with use of a rotational viscometer manufactured by AntonParr. Specifically, the viscosities were measured while a shear rate was increased from 0.1 sec⁻¹ to 10,000 sec⁻¹ over 400 seconds, and measured while the shear rate was continuously decreased from 10,000 sec⁻¹ to 0.1 sec⁻¹ over 400 seconds. Values measured while the shear rate was decreased were regarded as the viscosities at the given shear rates.

<Evaluation of Storage Property>

Each of the coating materials was put in a sample bottle which was made of glass and which had a capacity of mL, allowed to stand still for 24 hours at a room temperature, and storage property of the each of the coating materials was evaluated as below.
Good: No white sediment was observed on a bottom surface of the sample bottle after 24 hours.
Poor: A white sediment was observed on the bottom surface of the sample bottle after 24 hours.

<Evaluation of Solution Sending Property>

Solution sending property of each of the coating materials was evaluated as below by rotational viscometer measurement.
Good: A viscosity at a shear rate of 0.1 sec⁻¹ was not more than 1,000 Pa·sec.
Poor: A viscosity at a shear rate of 0.1 sec⁻¹ was more than 1,000 Pa·sec.

<Evaluation of Coating Property>

Each of the coating materials was applied to a commercially available polyethylene base material by a bar coater method. Such a polyethylene base material to which the each of the coating materials was applied was immediately washed with water so that a porous layer was disposed on the polyethylene base material. Thicknesses at five points of the polyethylene base material on which the porous layer was disposed were measured in accordance with a JIS standard (K7130-1992) with use of a high-resolution digital measuring device manufactured by Mitutoyo Corporation. By comparing variations (coefficient of variation), coating property of the each of the coating materials was evaluated as below.
Good: A coefficient of variation in thickness was less than ±5% with respect to an average of values measured at the five points.
Poor: The coefficient of variation in thickness was not less than ±5% with respect to the average of the values measured at the five points.

### Example 1

<Synthesis of Aromatic Polyester>

Into a reactor including a stirring apparatus, a torque meter, a nitrogen gas inlet tube, a thermometer, and a reflux condenser, 248.6 g (1.8 mol) of 4-hydroxybenzoic acid, 468.6 g (3.1 mol) of 4-hydroxyacetanilide, 681.1 g (4.1 mol) of isophthalic acid, 110.1 g (1.0 mol) of hydrochinone, and 806.5 g (7.90 mol) of acetic anhydride were introduced. A gas inside the reactor was sufficiently replaced with a nitrogen gas, and then a temperature inside the reactor was increased to 150° C. under a nitrogen gas airflow over a period of 15 minutes. While the temperature (150° C.) was maintained, a reaction solution was refluxed for 3 hours.

Thereafter, while an acetic acid, distilled as a byproduct, and an unreacted acetic anhydride were distilled away, the temperature was increased to 300° C. over a period of 300 minutes. At a time point at which an increase in torque was observed, it was determined that a reaction had ended. Then, a resultant content was extracted. The resultant content was cooled to a room temperature, and then was crushed with use of a crusher. An aromatic polyester powder having a relatively low molecular weight was thus obtained.

The aromatic polyester powder was subjected to a heat treatment at 290° C. in a nitrogen atmosphere for 3 hours so as to be subjected to solid phase polymerization. Thereafter, 100 g of wholly aromatic polyester thus obtained was added to 400 g of NMP, and then a resultant mixture was heated at 100° C. for 2 hours, so that 20% by weight aromatic polyester varnish was obtained.

<Synthesis of Aramid>

Poly(paraphenylene terephthalamide) (hereinafter, referred to as PPTA) was synthesized with use of a 5-liter separable flask having a stirring blade, a thermometer, a nitrogen in current canal, and a powder addition port.

The separable flask was sufficiently dried, and then 4,200 g of NMP was introduced into the separable flask. To the NMP, 272.65 g of calcium chloride which had been dried at 200° C. for 2 hours was added. A temperature inside the separable flask was then increased to 100° C. After the calcium chloride was completely dissolved, the temperature inside the separable flask was returned to a room temperature. To a resultant mixture, 132.91 g of paraphenylenediamine (hereinafter, referred to as PPD) was added. The PPD was completely dissolved, so that a solution was obtained. While a temperature of the solution was maintained at 20±2° C., 243.32 g of a terephthalic acid dichloride (hereinafter, referred to as TPC) was added, to the solution, in ten separate portions at approximately 5-minute intervals. Thereafter, while a temperature of a resultant solution was maintained at 20±2° C., the solution was matured for 1 hour. The solution was then stirred under reduced pressure for 30 minutes so as to eliminate air bubbles. A PPTA solution (6% by weight aramid resin solution) was thus obtained.

<Preparation of Coating Material>

15 g of 20% by weight aromatic polyester varnish (amount of resin: 3 g), 6 g of fumed alumina (central particle diameter: 0.01 μm), 6 g of high purity alumina (central particle diameter: 0.3 μm), and 50 g of a 6% by weight aramid resin solution (amount of resin: 3 g) were mixed together. A resultant mixture was diluted with NMP so that a solid content concentration was 6% by weight, and then stirred with use of a homogenizer. Next, the mixture thus obtained was dispersed twice at 50 MPa with use of a high-pressure dispersion homogenizer L01-YH1 manufactured by Sanwa Engineering Co. Ltd., so that a coating material was obtained. After the coating material was allowed to stand still for 24 hours, sedimentation of a filler was not observed.

### Example 2

A coating material was prepared as with the case of Example 1, except that a mixture of 20% by weight aromatic polyester varnish, fumed alumina, high purity alumina, and a 6% by weight aramid resin solution was diluted so that a solid content concentration was 9% by weight. After the coating material was allowed to stand still for 24 hours, sedimentation of a filler was not observed.

### Example 3

7.5 g of 20% by weight aromatic polyester varnish (amount of resin: 1.5 g), 6 g of fumed alumina (central particle diameter: 0.01 μm), 6 g of high purity alumina (central particle diameter: 0.3 μm), and 75 g of a 6% by weight aramid resin solution (amount of resin: 4.5 g) were mixed together. A resultant mixture was diluted with NMP so that a solid content concentration was 9% by weight, and then stirred with use of a homogenizer. Next, the mixture thus obtained was dispersed twice at 50 MPa with use of a high-pressure dispersion homogenizer L01-YH1 manufactured by Sanwa Engineering Co. Ltd., so that a coating material was obtained. After the coating material was allowed to stand still for 24 hours, sedimentation of a filler was not observed.

### Example 4

15 g of 20% by weight aromatic polyester varnish (amount of resin: 3 g), 6 g of fumed alumina (central particle diameter: 0.01 μm), 6 g of high purity alumina (central particle diameter: 0.3 μm), and 60 g of a 5% modified PVdF resin solution (amount of resin: 3 g) manufactured by Kureha Battery Materials Japan Co. Ltd. were mixed together. A resultant mixture was diluted with NMP so that a solid content concentration was 9% by weight, and then stirred with use of a homogenizer. Next, the mixture thus obtained was dispersed twice at 50 MPa with use of a high-pressure dispersion homogenizer L01-YH1 manufactured by Sanwa Engineering Co. Ltd., so that a coating material was obtained. After the coating material was allowed to stand still for 24 hours, sedimentation of a filler was not observed.

### Comparative Example 1

<Preparation of Coating Material>

15 g of 20% by weight aromatic polyester varnish (amount of resin: 3 g), 6 g of fumed alumina (central particle diameter: 0.01 μm), and 6 g of high purity alumina (central particle diameter: 0.3 μm) were mixed together. A resultant mixture was diluted with NMP so that a solid content concentration was 9% by weight, and then stirred with use of a homogenizer. Next, the mixture thus obtained was dispersed twice at 50 MPa with use of a high-pressure dispersion homogenizer L01-YH1 manufactured by Sanwa Engineering Co. Ltd., so that a coating material was obtained. After the coating material was allowed to stand still for 24 hours, sedimentation of a filler was observed.

### Comparative Example 2

50 g of 20% by weight aromatic polyester varnish (amount of resin: 10 g), 10 g of fumed alumina (central particle diameter: 0.01 μm), and 10 g of high purity alumina (central particle diameter: 0.3 μm) were mixed together. A resultant mixture was diluted with NMP so that a solid content concentration was 25% by weight, and then stirred with use of a homogenizer. Next, the mixture thus obtained was dispersed twice at 50 MPa with use of a high-pressure dispersion homogenizer L01-YH1 manufactured by Sanwa Engineering Co. Ltd., so that a coating material was obtained. After the coating material was allowed to stand still for 24 hours, sedimentation of a filler was observed.

### Comparative Example 3

6 g of fumed alumina (central particle diameter: 0.01 μm), 6 g of high purity alumina (central particle diameter: 0.3 μm), and 100 g of a 6% by weight aramid resin solution (amount of resin: 6 g) were mixed together. A resultant mixture was diluted with NMP so that a solid content concentration was 9% by weight, and then stirred with use of a homogenizer. Next, the mixture thus obtained was dispersed twice at 50 MPa with use of a high-pressure dispersion homogenizer L01-YH1 manufactured by Sanwa Engineering Co. Ltd., so that a coating material was obtained. After the coating material was allowed to stand still for 24 hours, sedimentation of a filler was not observed.

### Comparative Example 4

15 g of 20% by weight aromatic polyester varnish (amount of resin: 3 g), 6 g of fumed alumina (central particle diameter: 0.01 μm), 6 g of high purity alumina (central particle diameter: 0.3 μm), and 2.5 g of a 12% PVdF resin solution (amount of resin: 3 g) manufactured by Kureha Battery Materials Japan Co. Ltd. were mixed together. A resultant mixture was diluted with NMP so that a solid content concentration was 9% by weight, and then stirred with use of a homogenizer. Next, the mixture thus obtained was dispersed twice at 50 MPa with use of a high-pressure dispersion homogenizer L01-YH1 manufactured by Sanwa Engineering Co. Ltd., so that a coating material was obtained. After the coating material was allowed to stand still for 24 hours, sedimentation of a filler was observed.

[Measurement Results]

Table 1 shows results of measurement.

TABLE 1

| | | | Resin | Solid content | | | |
|---|---|---|---|---|---|---|---|
| | | | composition | concentration | Viscosity [Pa · sec] | | |
| | Resin 1 | Resin 2 | ratio | [% by weight] | 0.1 sec⁻¹ | 100 sec⁻¹ | 10,000 sec⁻¹ |
| Ex. 1 | Aromatic | Aramid | 1:1 | 6 | 6.77 | 0.47 | 0.04 |
| | polyester | | | | | | |
| Ex. 2 | Aromatic | Aramid | 1:1 | 9 | 39.42 | 1.29 | 0.08 |
| | polyester | | | | | | |
| Ex. 3 | Aromatic | Aramid | 1:3 | 9 | 81.30 | 0.31 | 0.02 |
| | polyester | | | | | | |
| Ex. 4 | Aromatic | Modified | 1:1 | 9 | 0.79 | 0.17 | 0.07 |
| | polyester | PVdF | | | | | |
| Comp. | Aromatic | — | — | 9 | 0.04 | 0.01 | 0.01 |
| Ex. 1 | polyester | | | | | | |
| Comp. | Aromatic | — | — | 25 | 0.37 | 0.31 | 0.21 |
| Ex. 2 | polyester | | | | | | |
| Comp. | — | Aramid | — | 9 | >1,000 | 2.37 | 0.12 |
| Ex. 3 | | | | | | | |
| Comp. | Aromatic | PVdF | 1:1 | 9 | 0.09 | 0.05 | 0.04 |
| Ex. 4 | polyester | | | | | | |

| | | | | | | Particle | | Terminal |
|---|---|---|---|---|---|---|---|---|
| | | | | Solution | | diameter | | velocity |
| | Thixotropic index | | Storage | sending | Coating | [μm] | | [mm/sec] |
| | 0.1/100 | 0.1/10,000 | property | property | property | D₅₀ | D₉₀ | Vₛ |
| Ex. 1 | 14 | 155 | Good | Good | Good | 1.06 | 2.22 | 1.2 |
| Ex. 2 | 31 | 467 | Good | Good | Good | 1.16 | 2.35 | 0.2 |
| Ex. 3 | 261 | 3486 | Good | Good | Good | 1.41 | 2.30 | 0.1 |
| Ex. 4 | 5 | 12 | Good | Good | Good | 0.97 | 2.03 | 8.5 |
| Comp. | 3 | 3 | Poor | Good | Good | 1.05 | 2.04 | 174 |
| Ex. 1 | | | | | | | | |
| Comp. | 1 | 2 | Poor | Good | Poor | 0.97 | 2.01 | 18 |
| Ex. 2 | | | | | | | | |
| Comp. | >400 | 20 | Good | Poor | Good | 1.13 | 1.96 | — |
| Ex. 3 | | | | | | | | |
| Comp. | 2 | 2 | Poor | Good | Good | 0.97 | 1.97 | 72 |
| Ex. 4 | | | | | | | | |

Abbreviation:
“Ex.” stands for “Example.”
“Comp. Ex.” stands for “Comparative Example.”

As is clear from Table 1, it was found that the coating materials of Examples 1 through 4, each of which coating materials had (i) a 0.1/100 thixotropic index of not less than 4 and not more than 400 and (ii) a 0.1/10,000 thixotropic index of not less than 5 and not more than 40,000, were good in storage property, solution sending property, and coating property.

In contrast, the coating materials of Comparative Examples 1, 2, and 4, each of which coating materials had (i) a 0.1/100 thixotropic index of less than 4 and (ii) a 0.1/10,000 thixotropic index of less than 5, were poor in storage property. The coating material of the Comparative Example 3, which coating material had a 0.1/100 thixotropic index of more than 400, was poor in solution sending property.

### INDUSTRIAL APPLICABILITY

The coating material in accordance with an aspect of the present invention is excellent in storage property, solution sending property, and coating property, and can be therefore widely used in a field of production of a nonaqueous electrolyte secondary battery.

1. A nonaqueous electrolyte secondary battery coating material for forming a porous layer by applying the nonaqueous electrolyte secondary battery coating material to an electrode or a porous base material of a nonaqueous electrolyte secondary battery, the nonaqueous electrolyte secondary battery coating material comprising:
a binder resin;
a filler; and
a solvent,
the nonaqueous electrolyte secondary battery coating material having (i) a first thixotropic index of not less than 4 and not more than 400, the first thixotropic index being obtained by dividing a viscosity of the nonaqueous electrolyte secondary battery coating material at a shear rate of 0.1 sec⁻¹ by a viscosity of the nonaqueous electrolyte secondary battery coating material at a shear rate of 100 sec⁻¹ and (ii) a second thixotropic index of not less than 5 and not more than 40,000, the second thixotropic index being obtained by dividing the viscosity of the nonaqueous electrolyte secondary battery coating material at the shear rate of 0.1 sec⁻¹ by a viscosity of the nonaqueous electrolyte secondary battery coating material at a shear rate of 10,000 sec⁻¹.

2. The nonaqueous electrolyte secondary battery coating material as set forth in claim 1, wherein the filler has a terminal velocity Vs of not more than 13 mm/sec, the terminal velocity Vs being obtained from the following Equation (1):
$${V}_{S} = \frac{{D}_{90} \times ( {ρ}_{filler} - {ρ}_{solvent} ) \times ℊ}{18 \times {η}_{( 0.1 sec - 1 )}} \qquad ( 1 )$$
where: D₉₀ represents a particle diameter at which, in a case where volumes of particles constituting the filler are summed up in ascending order of particle diameters, a sum of the volumes reaches 90% of a total volume of the particles; ρ_{filler} represents a density of the filler; ρₛₒₗᵥₑₙₜ represents a density of the solvent; g represents gravitational acceleration; and η_{(0.1 sec-1)} represents the viscosity of the nonaqueous electrolyte secondary battery coating material at the shear rate of 0.1 sec⁻¹ which viscosity is measured with use of a rheometer.

3. A nonaqueous electrolyte secondary battery porous layer obtained from a nonaqueous electrolyte secondary battery coating material recited in claim 1.

4. A nonaqueous electrolyte secondary battery laminated separator comprising:
a polyolefin porous film; and
a nonaqueous electrolyte secondary battery porous layer recited in claim 3.

5. A nonaqueous electrolyte secondary battery member comprising:
a cathode;
a nonaqueous electrolyte secondary battery porous layer recited in claim 3; and
an anode,
the cathode, the nonaqueous electrolyte secondary battery porous layer, and the anode being disposed in this order.

6. A nonaqueous electrolyte secondary battery comprising a nonaqueous electrolyte secondary battery porous layer recited in claim 3.

7. A nonaqueous electrolyte secondary battery member comprising:
a cathode;
a nonaqueous electrolyte secondary battery laminated separator recited in claim 4; and
an anode,
the cathode, the nonaqueous electrolyte secondary battery laminated separator, and the anode being disposed in this order.

8. A nonaqueous electrolyte secondary battery comprising a nonaqueous electrolyte secondary battery laminated separator recited in claim 4.
